(19) United States
(12) Patent Application Publication
(10) Pub. No.: US 2011/0148833 A1
(43) Pub. Date: Jun. 23, 2011

(54) ELECTROPHORETIC DISPLAY AND METHOD FOR ADJUSTTING DRIVING SETTINGS THEREOF

(75) Inventors: YING LUO, Shenzhen City (CN); CHUN-WEI PAN, Tu-Cheng (TW); KUAN-HONG HSIEH, Tu-Cheng (TW)

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 12/845,698

(22) Filed: Jul. 28, 2010

(30) Foreign Application Priority Data
Dec. 17, 2009 (CN) 200910311684.6

(51) Int. Cl. G09G 3/34; G09G 5/10; G09G 5/00

(52) U.S. Cl. 345/207; 345/690; 345/107

(57) ABSTRACT

A method for adjusting driving waveforms in an electrophoretic display includes: measuring grey level of the electrophoretic display periodically; comparing the measured grey level with a standard grey level, selecting a driving waveform from pre-stored driving waveforms according to the current grey level and the standard grey level if the measured grey level is not equal to the standard grey level; and applying the selected driving waveform to achieve the standard grey level. The electrophoretic display is also provided.

### BACKGROUND

1. Technical Field

The present disclosure relates to electrophoretic displays and, particularly, to an electrophoretic display with good performance under various environments, and a method for adjusting driving settings of the electrophoresis display to obtain good performance under various environments.

2. Description of Related Art

An electrophoretic display is a device based on the electrophoretic phenomenon of charged pigment particles dispersed in a solvent. The electrophoretic display usually includes two electrode plates placed opposite of each other and a display medium including charged pigment particles, dispersed in a solvent, sandwiched between the two electrode plates. When a voltage difference is imposed between the two electrode plates, the charged pigment particles may migrate to one side or the other, depending on the polarity of the voltage difference, to cause either the color of the pigment particles or the color of the solvent to be seen from the viewing side of the display. Optical performance of the electrophoresis display such as grey level changes according to environmental changes such as temperature variation, exposure time, aging of the electrophoresis display, and so on. The level of grey is achieved by driving settings such as length and voltage of a given driving waveform imposed between the two electrode plates.

In the case of temperature variation, typically, temperature sensors are incorporated to sense the change of temperature. Different driving waveforms are pre-programmed according to different changes of temperature. One driving waveform is selected and used to compensate for the change of temperature specifically. However, it is difficult to implement this specific driving waveform selection and temperature compensation because temperature sensors are often unreliable.

Therefore, it is desirable to provide an electrophoresis display which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electrophoretic display, according to one exemplary embodiment.

FIG. 2 is a flowchart of a method for adjusting driving waveforms of the electrophoretic display of FIG. 1 in accordance with an exemplary embodiment.

### DETAILED DESCRIPTION

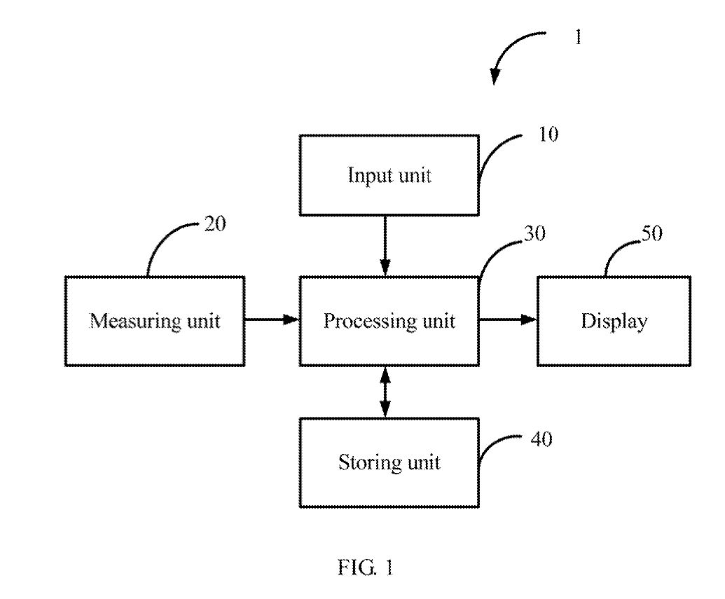

In order to make the present disclosure easier to understand, following paragraphs take grey level as an example of optical performance. Referring to FIG. 1, an embodiment of an electrophoretic display 1 is illustrated. The electrophoretic display 1 includes an input unit 10, a measuring unit 20, a processing unit 30, a storing unit 40, and a display 50.

The input unit 10 is configured for generating different operational signals in response to user input to control the electrophoretic display 1, for example, turning on/off the electrophoretic display 1. The display 50 is configured for displaying files. The measuring unit 20 such as an optical scanner is configured for periodically measuring a current grey level of the display 50.

The storing unit 40 is configured for supplying space to store data, such as driving waveforms corresponding to different changes of grey levels and a standard grey level. The driving waveforms are pre-programmed and can be applied to achieve different optical performances of the electrophoretic display 1. For example, if there is a calibration window with 24 blocks showing different grey levels, each block representative of the grey level is achieved by applying one driving waveform. Supposing a change of the grey levels such as from grey level 16 to 18 or 14 to 20 is wanted, an appropriate driving waveform corresponding to grey level 16 to 18 or 14 to 20 will be selected to drive the electrophoretic display 1, causing the grey level of the display 50 to reach 18 or 20, respectively. The standard grey level is used as a reference to achieve best image quality. Normally, a default driving waveform is applied to achieve the standard grey level. However, as time goes by, due to the change of temperature, exposure time and aging of the electrophoretic display 1, actual grey level may drift from the standard grey level if the default driving waveform is applied, thus adjustment of the driving waveform is needed.

The processing unit 30 is configured for comparing the measured grey level with the standard grey level. If the measured grey level is not equal to the standard grey level, one driving waveform is selected and applied according to the measured grey level and the standard grey level. For example, if the measured grey level is 14, and the standard grey level is 18, the driving waveform corresponding to grey level 14 to 18 is selected and applied to drive the electrophoretic display 1 to re-optimize image quality. The processing unit 30 is further configured for recording the selected driving waveform in the storing unit 40 as the default driving waveform.

Usually, the driving waveform is adjusted and applied, changing the optical performance, thus impacting output of the measuring unit 20 and achieving the standard grey level. Therefore, the obtaining of high performance of the electrophoretic display 1 does not need to be determined by the temperature changes, exposure time and aging of the electrophoretic display 1.

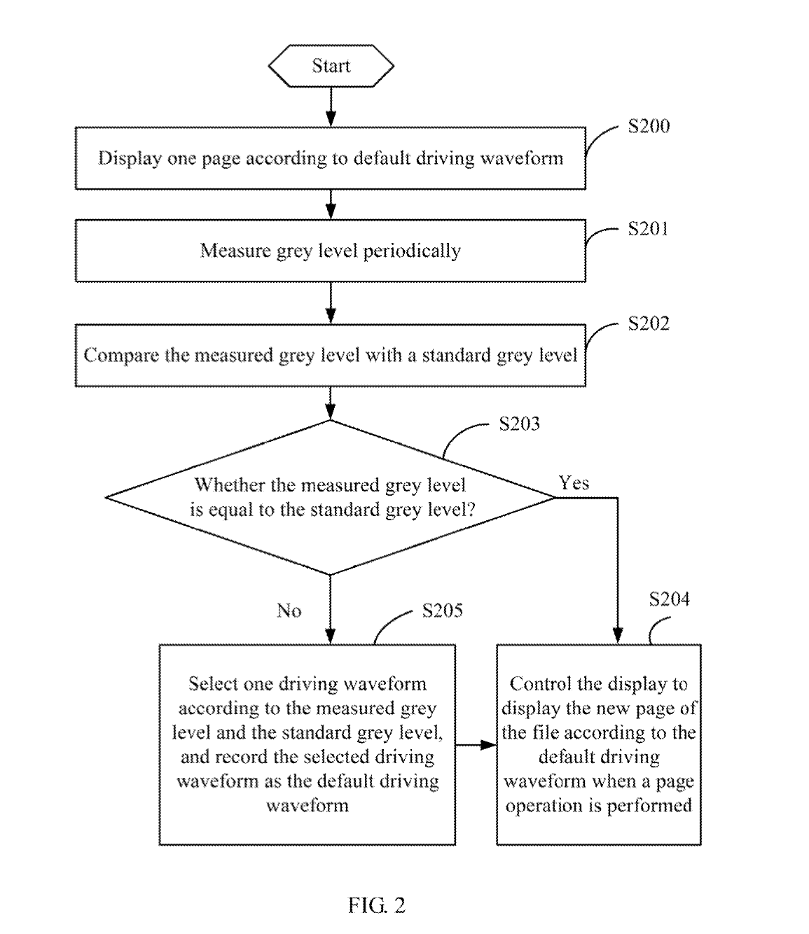

In the embodiment, the display 50 could display files according to the selected waveform when a page operation is performed. FIG. 2 is a flowchart of a method for selecting driving waveforms of the electrophoretic display 1 and displaying a new page according to the selected driving waveforms when the page operation is performed.

In step S200, the processing unit 30 controls the display 50 to display one page of the file according to the default driving waveform. In step S201, the measuring unit 20 measures the current grey level of the display 50 periodically. In step S202, the processing unit 30 compares the measured grey level with the standard grey level. In step S203, the processing unit 30 determines whether the measured grey level is equal to the standard grey level. If yes, the method goes to step S204, if no, the method goes to step S205. In step S204, the processing unit 30 controls the display 50 to display the new page of the file according to the default driving waveform when the page operation is performed. In step S205, the processing unit 30 selects one driving waveform according to the measured grey level and the standard grey level, and records the selected driving waveform as the default driving waveform, then the method goes back to step S204.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electrophoretic display comprising:
a measuring unit configured for measuring grey level of the electrophoretic display periodically;
a storing unit configured for storing a plurality of driving waveforms corresponding to different grey levels, and a standard grey level of the electrophoretic display; and
a processing unit configured for comparing the measured grey level with the standard grey level, selecting one driving waveform from the plurality of the driving waveforms according to the measured grey level and the standard grey level if the measured grey level is not equal to the standard grey level, and applying the selected driving waveform to achieve the standard grey level.

2. The electrophoretic display according to claim 1, wherein the processing unit is further configured for storing the selected driving waveform in the storing unit as a default driving waveform.

3. The electrophoretic display according to claim 1, wherein the driving waveforms are pre-programmed.

4. The electrophoretic display according to claim 1, wherein the measuring unit is an optical scanner.

5. The electrophoretic display according to claim 1, further comprising an input unit configured for generating different operational signals in response to user input to control the electrophoretic display.

6. The electrophoretic display according to claim 1, further comprising a display configured for displaying files.

7. The electrophoretic display according to claim 1, wherein the electrophoretic display displays the files according to the selected driving waveform when a page operation is performed.

8. A method for adjusting driving waveforms in an electrophoretic display, comprising:
measuring grey level of the electrophoretic display periodically;
comparing the measured grey level with a standard grey level;
selecting a driving waveform from a plurality of pre-stored driving waveforms according to the measured grey level and the standard grey level if the measured current grey level is not equal to the standard grey level; and
applying the selected driving waveform to achieve the standard grey level.

9. The method according to claim 8, further comprising recording the selected driving waveform as a default driving waveform.

10. The method according to claim 8, further comprising displaying files according to the selected driving waveform when a page operation is performed.
